(19) United States
(12) Patent Application Publication
(10) Pub. No.: US 2006/0113330 A1
(43) Pub. Date: Jun. 1, 2006

(54) Lever Actuated Measured Fluid Dispenser

(76) Inventors: Don Byron Walker II., Gardendale, AL (US); Jerrod Bradley Windham, Birmingham, AL (US); Lloyd Bowers Cooper, Birmingham, AL (US)

Correspondence Address: Push Product Design, LLC, 2212 2nd Ave North, Birmingham, AL, 35203, US

(21) Appl. No.: 10/904,815

(22) Filed: Nov. 30, 2004

(51) Int. Cl. B67D 1/00

(52) U.S. Cl. 222/441; 222/472

(57) ABSTRACT

There is a significant market for liquid detergent bottles in the approximate size of 100 fluid ounces. The advantages of this size and design of current containers include convenient value bulk size and the ability to pick up and grasp with one hand for transport and use. A major disadvantage of current designs is that this size and weight container are at the upper limit of what a small woman or elderly user can comfortably hold. A further disadvantage is that the current use/operating sequence of unscrewing the cap, pouring the bottle into the cap, dispensing the cap and then re-attaching the cap requires the careful use of both hands. A final disadvantage is that undesirable residue from the liquid often adheres to rim and surfaces on and around the container due to drips and spills. The objective of this new and improved design is to provide a container that is both easier to use and cleaner to operate, through an automatic, self-dispensing operation that reseals itself after use.

### UNIQUE DESIGN

The unique design incorporates a lever-operated, measured dispensing device for one-handed use. This device is composed of an internal shuttle chamber with openings at two locations. As the entire container is tipped forward, fluid enters and fills the shuttle through the fill opening. Because the chamber is restricted to a certain size, a predefined measured amount of fluid is allowed to enter the chamber. When the user has positioned the device over the desired location, he depresses the lever with his thumb. The lever moves the shuttle, within the container, from a fill position to a dispense position. As the shuttle is moved out of the fill position, the fill opening in the shuttle is blocked from receiving any additional fluid from the main container body. When the shuttle reaches the dispense position, the dispense opening is aligned with the opening in the top portion of the pour spout. Fluid is then allowed to empty out of the shuttle, through the pour spout opening and into the desired target location. No additional fluid from the primary container is allowed to empty out of the shuttle.

### USE AND OPERATION

To use the device, the user picks up the container in a manner similar to picking up a water pitcher and holds it in a tipped position over the target location. The user then grasps the thumb lever. When the user tips the dispenser forward and depresses the thumb lever, a measured quantity of fluid is dispensed. Regardless of how long the thumb lever is held open while the dispenser is tipped forward, no additional fluid can escape. When the user is finished with the dispensing operation, they place the unit down and release the thumb lever. The cap automatically reseals itself. Any fluid residue is trapped by the pour rim and funneled back into the container - leaving no exposed residue.

Form/Structure

The design is based around a standard size container with a larger, improved handle for easier grasping. The top of the unit incorporates a lever, which extends adjacent to top of the handle. The overall body of the unit is distinguished by a triangular, ellipsoid shape, which is caped by a top component of the same shape. Numerous body designs could be offered with the same internal mechanism. The goal of the overall form is to provide unique function and improved ergonomics with a distinguishing visual form to differentiate from conventional containers. Further body designs are anticipated which could provide both improved stacking and/or container nesting. These additional designs may offer improved shipping and denser shelf storage benefits.

Manner or Process of Making

This invention can be made using similar processes to conventional fluid detergent containers. The design is composed of 6 main components.

Lever

The lever handle is an injection molded plastic part with pivot bosses that snap into the top component.

Top

The top is an injection molded plastic part with recessed cavities. The base of the cap has a screw and/or snap lip which attaches securely to the main body. A cylindrical central underbody acts as a sleeve channel to support the shuttle.

Shuttle

The shuttle is an injection molded plastic part composed of a cylinder and top surface component with an upper and lower opening.

Spring

The spring is a standard steel coil spring. Optional designs may include forming the spring out of plastic as a separate component or as a portion of the top or shuttle component.

Retaining Cap

The retaining cap is an injection molded plastic part that is formed to snap over (or be adhered to) the lower lip of the cylindrical center body of the top.

Main Body

The main body is composed of a blow-molded or injection molded, single piece plastic container. The size of the unit is designed to hold approximately 100 fluid ounces. A side handle and top located mounting rim are formed into the container body. Optional sizes could vary significantly for different applications.

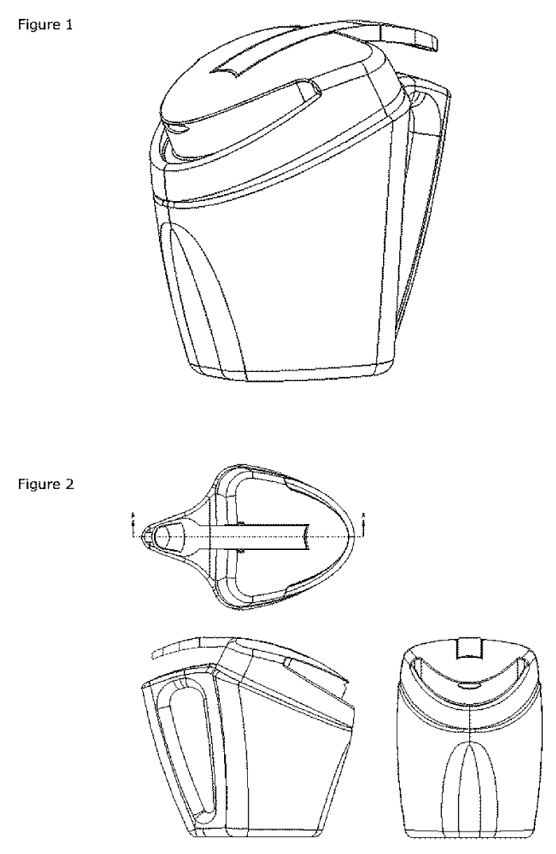

FIG. 1 illustrates an isometric view of the entire dispenser assembly

FIG. 2 illustrates the dispenser in top, side and front views with the section line used to create FIG. 1 and FIG. 2

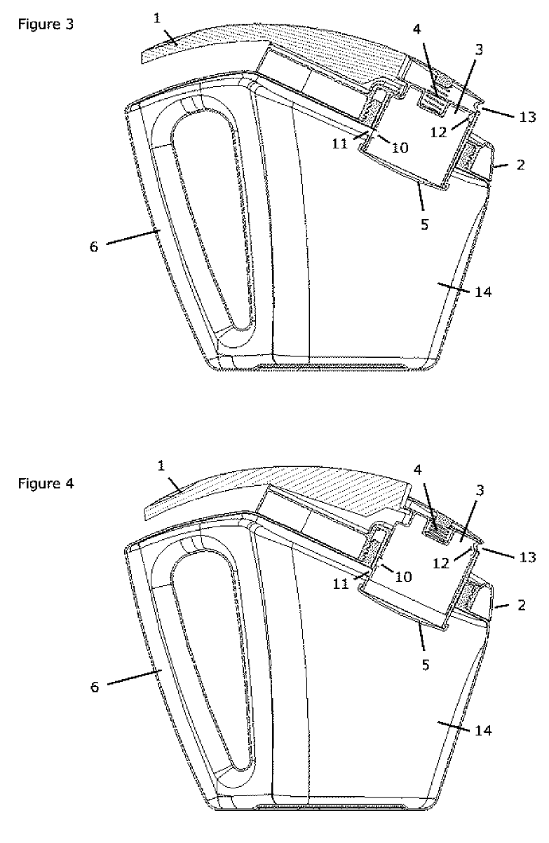

FIG. 3 illustrates the dispenser with the lever 1 in the normal, non-actuated position. The top 2 holds the shuttle 3 in between the spring 4 and the retaining cap 5. The shuttle fill opening 10 is aligned with the top fill opening 11 so that the contents of the main body can enter the shuttle. The shuttle pour opening 12 is blocked. The main body 6 is shown with side handle.

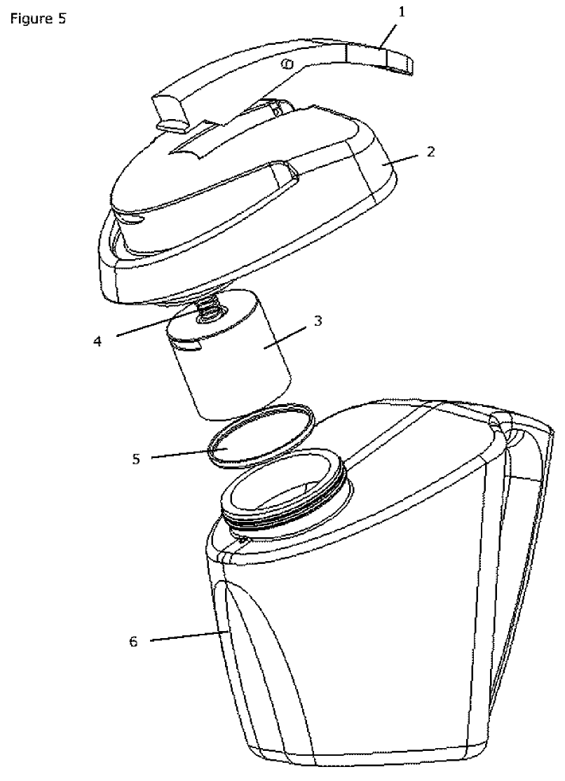

FIG. 4 illustrates the dispenser with the lever 1 in the actuated position and the shuttle 3 raised into pouring position. The shuttle fill opening 10 is now blocked. The shuttle pour opening 12 is now aligned with the top pour opening 13 so that the contents of the shuttle can be poured out.

FIG. 5 illustrates the dispenser as an exploded view. Lever 1, top 2, shuttle 3, spring 4, retaining cap 5, and main body 6 are shown separated.

What is claimed is:

1. A container for pre-measuring an amount of fluid or powder to be poured from said container, said container comprising:
an inner chamber (14) for storing a medium,
a retaining cap (2),
a shuttle actuating means (1) which moves the shuttle structure (3),
a shuttle structure (3) which is slidingly movable inside the retaining cap (2),
wherein the shuttle, in its upper position, simultaneously seals off the inner chamber opening (11) while opening the exterior pour spout opening (13), and, in its downward position, simultaneously opens the inner chamber opening (11) while closing the exterior pour spout (13).
